(19) United States
(12) Patent Application Publication
(10) Pub. No.: US 2012/0106464 A1
(43) Pub. Date: May 3, 2012

(54) SPECTRUM SHARING WITH IMPLICIT POWER CONTROL IN COGNITIVE RADIO NETWORKS

(75) Inventors: Miao Ma, Hong Kong (CN); Danny Hin Kwok Tsang, Hong Kong (CN)

(73) Assignee: THE HONG KONG UNIVERSITY OF SCIENCE AND TECHNOLOGY, Hong Kong (CN)

(21) Appl. No.: 13/089,851

(22) Filed: Apr. 19, 2011

Related U.S. Application Data
(60) Provisional application No. 61/407,428, filed on Oct. 27, 2010.

(51) Int. Cl. H04W 52/04

(52) U.S. Cl. 370/329

(57) ABSTRACT

Providing for a cross-layer spectrum sharing model incorporating implicit power control for cognitive radio wireless communication is described herein. By way of example, a binary integer linear programming problem is formulated to establish active wireless links among secondary user nodes in a cognitive radio, ad-hoc network. The formulation reuses wireless channels among multiple activated links within disclosed interference constraints, and assigns a power level for transmissions on respective links. Additionally, the formulation employs bi-directional wireless links for the ad-hoc network, improving communication within the ad-hoc network. Further, power level assignments can be predefined and implicitly embedded in the formulation to reduce complexity.

### CLAIM OF PRIORITY UNDER 35 U.S.C. §119

The present Application for Patent claims priority to Provisional Patent Application Ser. No. 61/407,428 entitled “EFFICIENT SPECTRUM SHARING IN COGNITIVE RADIO NETWORKS WITH IMPLICIT POWER CONTROL,” filed Oct. 27, 2010, and hereby expressly incorporated by reference herein.

### TECHNICAL FIELD

The present application relates generally to spectrum sharing in cognitive radio networks and more specifically to providing centrally managed efficient spectrum utilization with implicit power control for cognitive radio wireless communication.

### BACKGROUND

In modern wireless communications, most wireless networks operate on a particular licensed or unlicensed wireless frequency. Different types of wireless communications, such as cellular communications, paging communications, amateur radio communications, and so on, have different frequency spectra assigned as standard frequencies for electronic devices employing these types of communications. Different states or national governments might modify these frequencies within their jurisdictions to some extent, but generally the frequency employed for a given wireless system, IEEE 802.11 local area networks for instance, will be the same worldwide.

As some modes of wireless communications have become increasingly popular, their associated frequency spectra have become increasingly crowded. As an example, the frequency spectrum generally employed by cellular telephone communications is more crowded than that employed by amateur radio, due to the relative popularity of these two forms of wireless communication. As a result of such divergent utilization of various modes of wireless communication, some frequency spectra can be congested, whereas others are relatively free. This imbalance in utilization of frequency spectra has lead to an inefficient use of the overall radio frequency spectrum.

Cognitive radio was first proposed as a mechanism for providing a more intelligent and adaptive paradigm for wireless communication. This mechanism looks to leverage the relatively ubiquitous smart-phone type mobile communication devices having sophisticated software logic to accomplish adaptive and dynamic wireless communications. Initial proposals for cognitive radio envisioned computer to computer communications sufficiently refined to detect user communication needs as a function of use context, and deliver radio resources or wireless services configured particularly for those needs. However, no conventional system has achieved a fully reconfigurable wireless system that adapts its communication variables in response to network and user demands.

Although many conceptual proposals for cognitive radio are yet to achieve any realization, those addressing frequency spectra utilization have already been initiated. This is largely because the inefficient use of radio frequencies has become such an immediate and multi-faceted problem. For instance, fixed spectrum allocation for systems like cellular networks, prevent rarely used frequencies (e.g., assigned to specific services such as broadcast television) from being used by unlicensed users. This is so even where additional transmissions on those frequencies would not interfere with the assigned service.

One of the first applications of cognitive radio, therefore, involves use of radio spectra licensed or otherwise pre-allocated for one set of communication devices or wireless services, by a different set of wireless communication devices or for different services. One basic constraint of these applications involves avoiding potential collisions on the licensed or otherwise pre-allocated frequency spectra. Thus, cognitive radio systems have been developed to sense legitimate user presence on a given spectrum and avoid utilizing that spectrum in a manner that would cause a collision. When no user presence is detected, the cognitive radio system attempts to utilize the spectrum to a greater degree, or without constraint. This can be accomplished by active monitoring of several factors in the external and internal radio environment, including radio frequency spectrum, user behavior and network state.

One problem of interest in cognitive radio wireless communication is efficient sharing of non-utilized or under-utilized frequencies by non-licensed or otherwise atypical wireless devices (also referred to as secondary user equipment). Some spectrum sharing proposals assume uni-directional links to reduce complexity of frequency sharing algorithms. Other proposals ignore power control in conjunction with spectrum sharing. However, no conventional system provides a robust spectrum sharing algorithm that contemplates adequate constraints to meet real world wireless communication concerns.

The above-described deficiencies of conventional cognitive radio techniques are merely intended to provide an overview of some problems of current technology, and are not intended to be exhaustive. Other problems with the state of the art, and corresponding benefits of some of the various non-limiting embodiments described herein, may become further apparent upon review of the following detailed description.

### SUMMARY

The following presents a simplified summary to provide a basic understanding of some aspects of the various embodiments. This summary is not an extensive overview of the various embodiments. It is intended to neither identify key or critical elements of the various embodiments nor delineate the scope of such embodiments. Its sole purpose is to present some concepts of the various embodiments in a simplified form as a prelude to the more detailed description that is presented later.

Various aspects of the subject disclosure provide for a cross-layer spectrum sharing model incorporating implicit power control for cognitive radio wireless communication. According to particular aspects, a binary integer linear programming problem is formulated to establish active wireless links among secondary user nodes in an ad-hoc network. The formulation reuses wireless channels among multiple activated links within disclosed interference constraints, and assigns a power level for transmissions on respective links. Additionally, the formulation can assume bi-directional wireless links for the ad-hoc network, incorporating transmission acknowledgments among pairs of secondary user nodes. Further, power level assignments can be predefined and implicitly embedded in the formulation to reduce complexity.

At least one aspect of the subject disclosure provides a system for cognitive radio wireless communication comprising at least a sorting component, a reference component, and a scheduling component. The sorting component can be configured to classify respective bi-directional wireless links formed by a set of secondary user nodes operating as an ad-hoc network in a cognitive radio arrangement. The reference component can be configured to correlate a node transmit power with a class of a bi-directional wireless link. Moreover, the scheduling component can be configured to assign the node transmit power to nodes participating in the bi-directional wireless link according to the class of the bi-directional wireless link.

Other aspects disclose a method of cognitive radio wireless communication. The method can comprise identifying a set of potential bi-directional links between secondary user nodes that are configured for ad-hoc networking. Moreover, the method can comprise activating a maximum number of the set of potential bi-directional links subject to a set of constraints, the set of constraints comprises at least an interference constraint. The method can further comprise assigning a transmit power to an activated bi-directional link that is predetermined from a characteristic of the activated bi-directional link.

In yet other aspects, the subject disclosure provides a system for wireless communication. The system can comprise a means for maximizing channel reuse in assigning available wireless channels to ad-hoc wireless communication among pairs of secondary user nodes, subject at least to an interference constraint. Furthermore, the system can comprise means for assigning a transmit power to one pair of nodes that is predetermined from a location characteristic of the respective pair of nodes.

The following description and the annexed drawings set forth in detail certain illustrative aspects of the various embodiments. These aspects and their equivalents are indicative, however, of but a few of the various ways in which the principles of the various embodiments may be employed, and such embodiments should thus not be limited to any particular aspect or aspects described herein. Other advantages and distinguishing features of the various embodiments will become apparent from the following detailed description when considered in conjunction with the drawings.

### BRIEF DESCRIPTION OF THE DRAWINGS

FIG. 1 illustrates a block diagram of a sample system that provides efficient spectrum sharing with implicit power control in cognitive radio applications.

FIG. 2 depicts a diagram of an example discrete level link classification mechanism for implicit power control in cognitive radio according to some aspects.

FIG. 3 illustrates a block diagram of an example cognitive radio base station that provides spectrum sharing, channel assignment and power control for an ad-hoc network of secondary user nodes according to other aspects.

FIG. 4 depicts a diagram of an example homogeneous distribution of secondary user nodes and optimal spectrum allocation according to one or more aspects.

FIG. 5 depicts a diagram of a sample heterogeneous distribution of secondary user nodes and optimal spectrum allocation according to further aspects.

FIG. 6 illustrates a diagram of an example set of intra-cluster and inter-cluster wireless links for the heterogeneous distribution of FIG. 5.

FIG. 7 depicts a flowchart of a sample method for providing efficient spectral utilization in cognitive radio according to still other disclosed aspects.

FIGS. 8 and 9 illustrate a flowchart of an example method of channel assignment and implicit power control in spectrum utilization for cognitive radio.

FIG. 10 depicts a block diagram of an example computer operable to execute at least some aspects of the disclosed systems or methods.

FIG. 11 illustrates a block diagram of an exemplary electronic communication environment according to additional aspects.

### DETAILED DESCRIPTION

The various embodiments are now described with reference to the drawings, wherein like reference numerals are used to refer to like elements throughout. In the following description, for purposes of explanation, numerous specific details are set forth in order to provide a thorough understanding of the various embodiments. It may be evident, however, that the various embodiments may be practiced without these specific details. In other instances, well-known structures and devices are shown in block diagram form in order to facilitate describing the various embodiments.

As used in this application, the terms “component,” “module,” “system”, or the like can refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the various embodiments may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Of course, those skilled in the art will recognize many modifications may be made to this configuration without departing from the scope or spirit of the various embodiments.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

In cognitive radio (CR) there are typically two types of user equipment, primary user equipment (which includes primary user terminals) and secondary user equipment (also referred to as secondary user nodes, which includes secondary user terminals, or SUTs). Primary user equipment is generally some kind of wireless interface device (e.g., wireless transmitter, wireless receiver, wireless transceiver, . . . ) that is licensed for a particular frequency spectrum, or employs a service allocated to the particular frequency spectrum. Secondary user equipment, on the other hand, is typically not licensed on the particular frequency, or utilizes a different service than what the frequency spectrum is allocated for. As an example, a cellular phone is a SUT on a frequency spectrum allocated for broadcast television, as the cellular phone utilizes a different service (e.g., cellular wireless communications as opposed to reception of broadcast television) than what this frequency spectrum is allocated for. As yet another example, the cellular phone can be a secondary user on a frequency spectrum allocated for 802.11 wireless communications, if the cellular phone is not licensed to utilize the frequency spectrum allocated for 802.11 wireless communications, and so on.

Cognitive radio employs a channel sensing mechanism to avoid causing interference to primary user equipment on frequencies employed by the primary user. By sensing a channel, an estimate of whether transmissions are occurring on that channel at a given point in time can be made. Channels estimated to be idle, having no transmissions, can be employed for traffic transmissions of secondary user equipment. Channels estimated to be busy are avoided by secondary user equipment. In this manner, secondary user nodes identify channels as unused and access them opportunistically.

Secondary user nodes typically organize among themselves an ad-hoc network. Transmissions among these secondary user nodes can be accomplished on channels identified as unused, or otherwise available. Different from multi-channel multi-radio networks where a set of channels available at each node is identical, in CR networks the set of available channels can be different from node to node.

Several typical problems occur when attempting to solve the channel allocation problem for CR networks. One problem, for instance, involves determining which neighboring node(s) that a secondary user node will communicate within an ad-hoc network. Another example problem involves determining what channel(s) respective groups of nodes should utilize for these communications. Yet another example problem is determining a transmit power level for these communications.

The subject disclosure provides a cross-layer optimization framework to jointly design spectrum sharing and power control for secondary user nodes participating in an ad-hoc network. The optimization framework can include various constraints on channel reuse, including an interference constraint for instance. Further, the optimization framework utilizes bi-directional links among nodes to enable transmission acknowledgments (e.g., link level acknowledgments) in the ad-hoc network. An example of bi-directional links can include an 802.11-style protocol interference model, among others.

In addition to the foregoing, spectrum sharing optimization can incorporate implicit power control. As one example, the implicit power control can be based on a classification of bi-directional links, where a link class is determinative of transmit power employed for that link. As a result, power control can be implicitly embedded in the optimization framework, simplifying channel allocation as compared with techniques that consider power control to be a decision variable at each node.

Various example applications of channel allocation optimization are disclosed herein. An example optimization formulation is provided based on a binary integer linear programming (BILP) algorithm. Various constraints are also constructed to model real world considerations pertinent to cognitive radio wireless communication. These constraints are then applied to the BILP algorithm in multiple example ad-hoc network scenarios.

In one example scenario, the optimization framework is applied to a homogeneous distribution of secondary user nodes. The spectrum efficiency that results with this example scenario is significantly improved over channel allocation without power control. In another example scenario, the optimization framework is applied to a heterogeneous distribution of secondary user nodes. In this latter example scenario, clusters of secondary user nodes are also identified, and intra-cluster links and inter-cluster links established, with the aforementioned power control. It should be appreciated that node clustering can be applied to other example node distributions, including the homogeneous distribution, even if not specifically addressed in various examples disclosed herein.

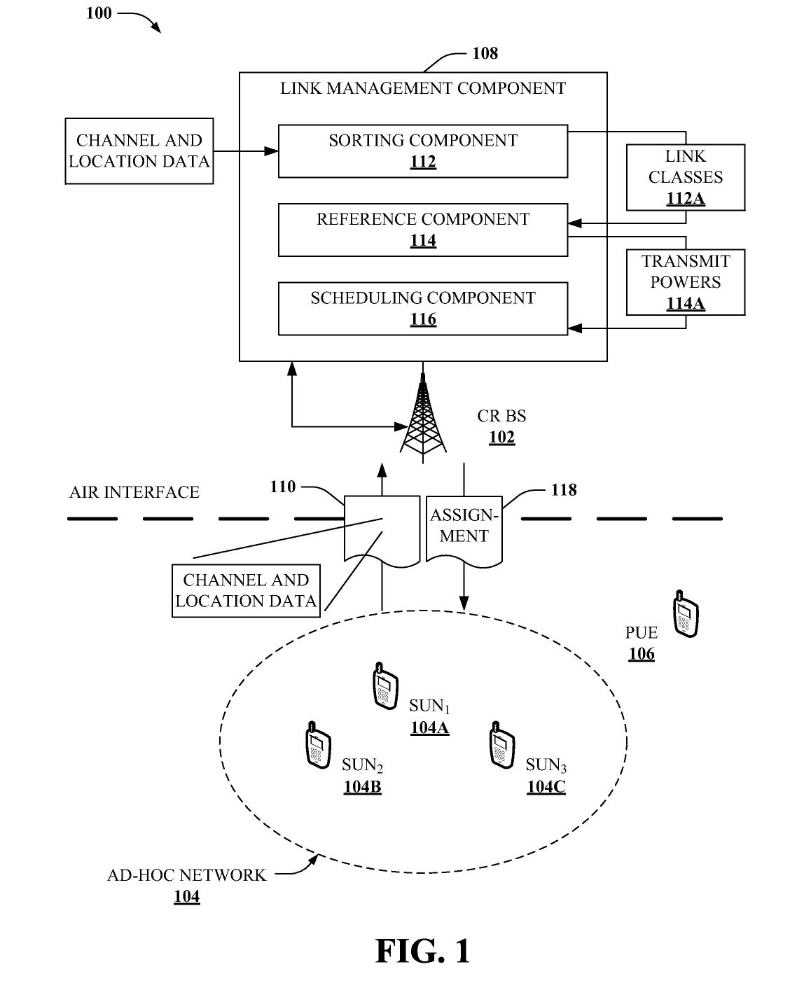

Referring now to the drawings, FIG. 1 illustrates a block diagram of an example cognitive radio wireless communication system 100 (system 100) that incorporates implicit power control for spectrum sharing, according to one or more aspects of the subject disclosure. System 100 can comprise a CR base station 102 and an ad-hoc network 104 of secondary user nodes, including secondary user node₁ 104A, secondary user node₂ 104B, secondary user node₃ 104C, . . . , (referred to collectively as secondary user nodes 104A-104C). Additionally, system 100 can include one or more primary user equipment 106, participating in wireless communication on a frequency spectrum allocated for primary user equipment 106, or for wireless services consumed by primary user equipment 106.

Primary user equipment 106 sends or receives wireless signals on an allocated frequency spectrum as determined by suitable protocols associated with primary user equipment 106. Secondary user nodes 104A-104C, on the other hand, sense the allocated frequency spectrum and access it opportunistically. In other words, when a secondary user node identifies a set of wireless channels as empty (e.g., no transmissions on the set of channels), the secondary user node can attempt to utilize one or more of these channels for wireless communication. This wireless communication can comprise transmissions within ad-hoc network 104, or between CR base station 102 and the secondary user node, or a suitable combination thereof.

In at least one aspect of the subject disclosure, secondary user nodes 104A-104C employ bi-directional wireless links among respective subsets of nodes for the ad-hoc network. This enables acknowledgment-related transmissions among respective nodes, to improve communication quality for ad-hoc network 104. For instance, in one example, link level acknowledgment can be employed by the secondary user nodes as part of ad-hoc network 104. In at least one particular aspect, ad-hoc network 104 employs medium access controls based on an IEEE 802.11 model and incorporates one or more bi-directional assumptions utilized in IEEE 802.11 wireless communication (e.g., a request to send (RTS)—clear to send (CTS) exchange).

Upon sensing wireless channels for availability, one or more of secondary user nodes 104A-104C can transmit channel availability to CR base station 102 in an uplink message 110. In one aspect of the subject disclosure, respective secondary user nodes share available channel information within ad-hoc network 104, and a subset of secondary user nodes 104A-104C transmit uplink message 110. In this case, the subset of secondary user nodes can identify within the message which channel information is reported by which secondary user node 104A, 104B, 104C. In another aspect, respective secondary user nodes 104A-104C separately transmit respective wireless channel availability information to CR base station 102.

In addition to wireless channel information, secondary user nodes 104A-104C can include location information for the respective nodes within uplink message 110. In one instance, the location information can include respective geographical locations of the respective secondary user nodes (e.g., derived from global positioning system data, from latitude/longitude system data, from network triangulation system data, or the like, or a suitable combination thereof). In another instance, the location information can include location information in addition to inter-node distance information (e.g., comprising a distance between subsets of secondary user nodes 104A-104C), which can be calculated from the location information, calculated from signal power loss between subsets of nodes, or the like.

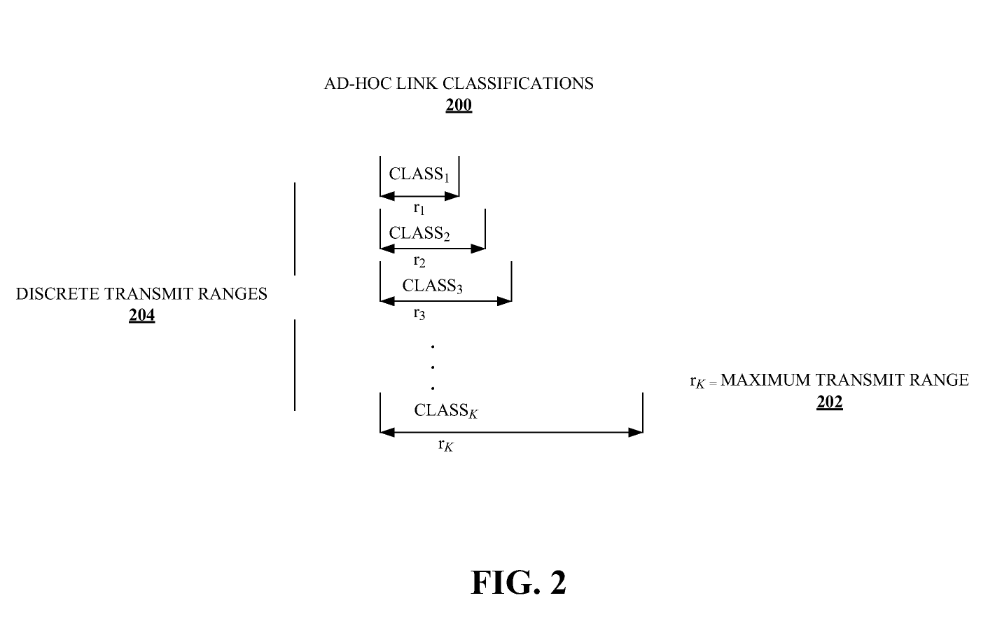

A link management component 108 associated with CR base station 102 receives location and channel information transmitted by secondary user nodes 104A-104C. Link management component 108 can comprise a sorting component 112 configured to classify respective bi-directional wireless links formed by secondary user nodes 104A-104C operating in ad-hoc network 104. According to one aspect of the subject disclosure, sorting component 112 classifies respective bi-directional wireless links of ad-hoc network 104 as a function of respective distances between nodes participating in the respective wireless links. In this aspect, sorting component 112 can establish a plurality of classes for the wireless links, where each class is defined by a set of discrete distances. The set of discrete distances can be derived from suitable transmit ranges (e.g., subsets of mutually exclusive transmit ranges), suitable inter-node distances for respective pairs of nodes, or the like (e.g., see FIG. 2, infra).

Once established, sorting component 112 provides the classes of bi-directional wireless links to reference component 114. Reference component 114 can be configured to correlate node transmit power with a class of bi-directional wireless link. This correlation can be based, for instance, on a number of link classes, or a suitable range of transmit powers for secondary user nodes 104A-104C. The number of link classes and range of transmit powers can be employed to establish mutually exclusive transmit range classes, which can be correlated implicitly to a set of transmit powers (e.g., see FIG. 2, infra).

Scheduling component 116 can be configured to assign the node transmit power to nodes participating in the bi-directional wireless link according to the correlation of transit power and class of the bi-directional wireless link, established by reference component 116. Thus, scheduling component 114 employs location information reported by secondary user nodes 104A-104C to determine a distance between nodes associated with a bi-directional wireless link. This distance is compared to a transmit range class encompassing the distance, and a transmit power correlated to the transmit range class is obtained from reference component 114. Scheduling component 116 then assigns the received transmit power to nodes participating in the bi-directional wireless link. The foregoing procedure can be repeated for other bi-directional wireless links between nodes of ad-hoc network 104. It is worth noting that the correlation of transmit power to classes of bi-directional wireless links (based on transmit range, for instance) reduces complexity of power control assignments, by not establishing transmit power as a decision variable, but rather an implicit correlation to link classification.

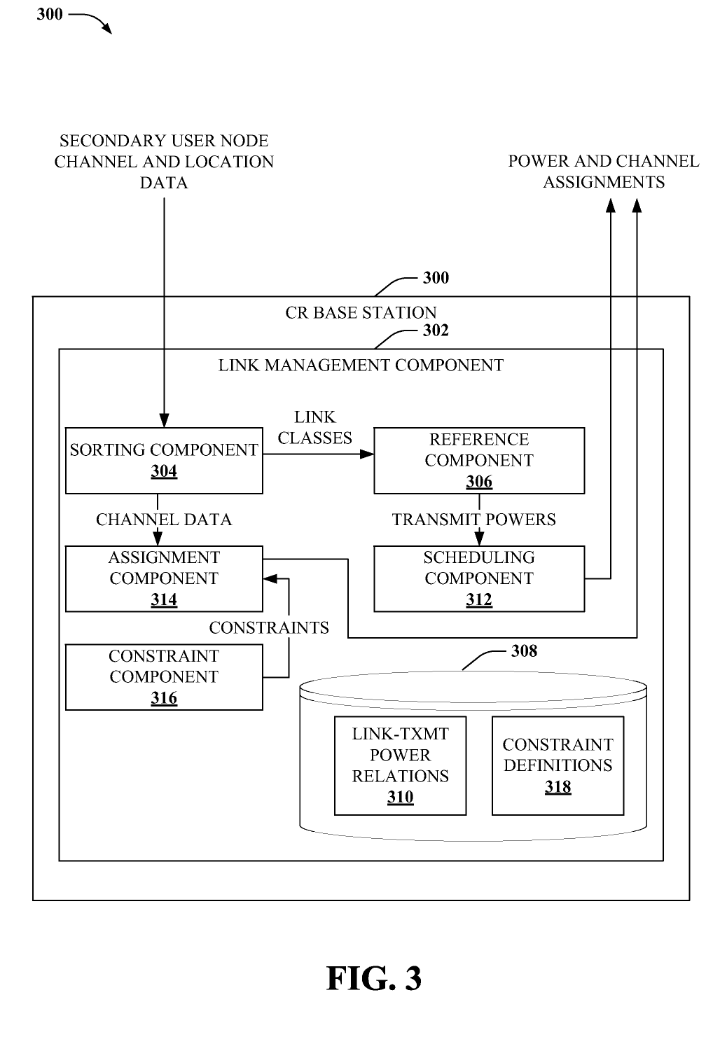

Once respective transmit powers are determined for subsets of secondary user nodes 104A-104C, CR base station 102 transmits these transmit powers in an assignment message 118 to one or more secondary user nodes of ad-hoc network 104. As described in more detail, infra, additional assignments can be included in assignment message 118. These additional assignments can include, for instance, particular bi-directional links to be activated for ad-hoc communication among nodes, wireless channels assignments employed for the communication, and so on (e.g., see FIG. 3, infra).

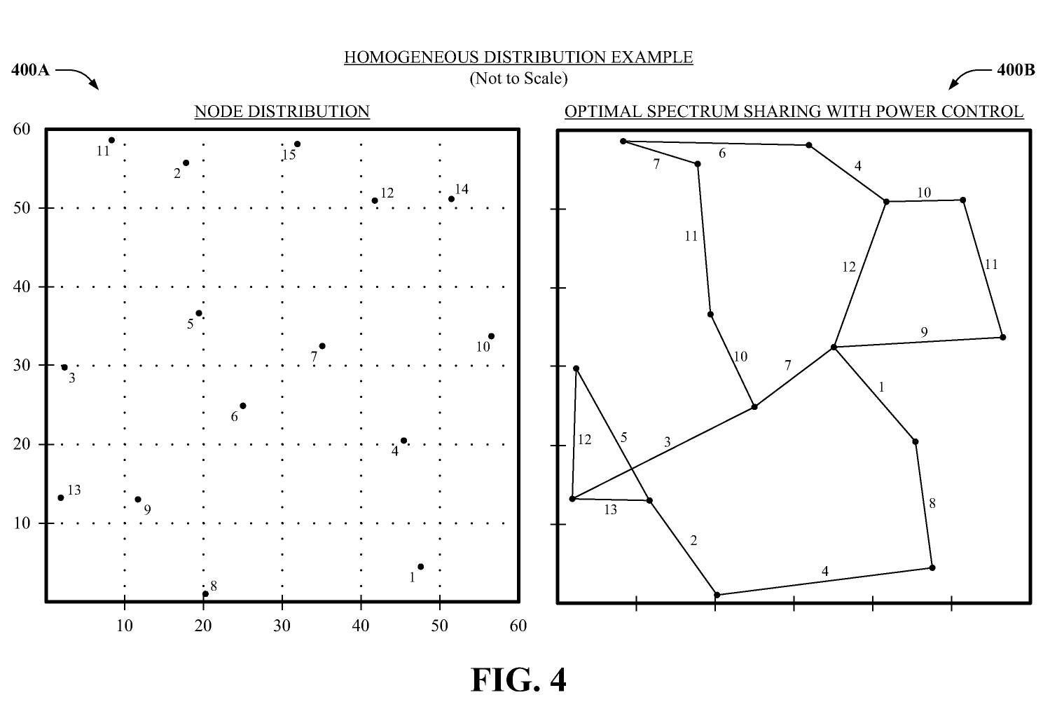

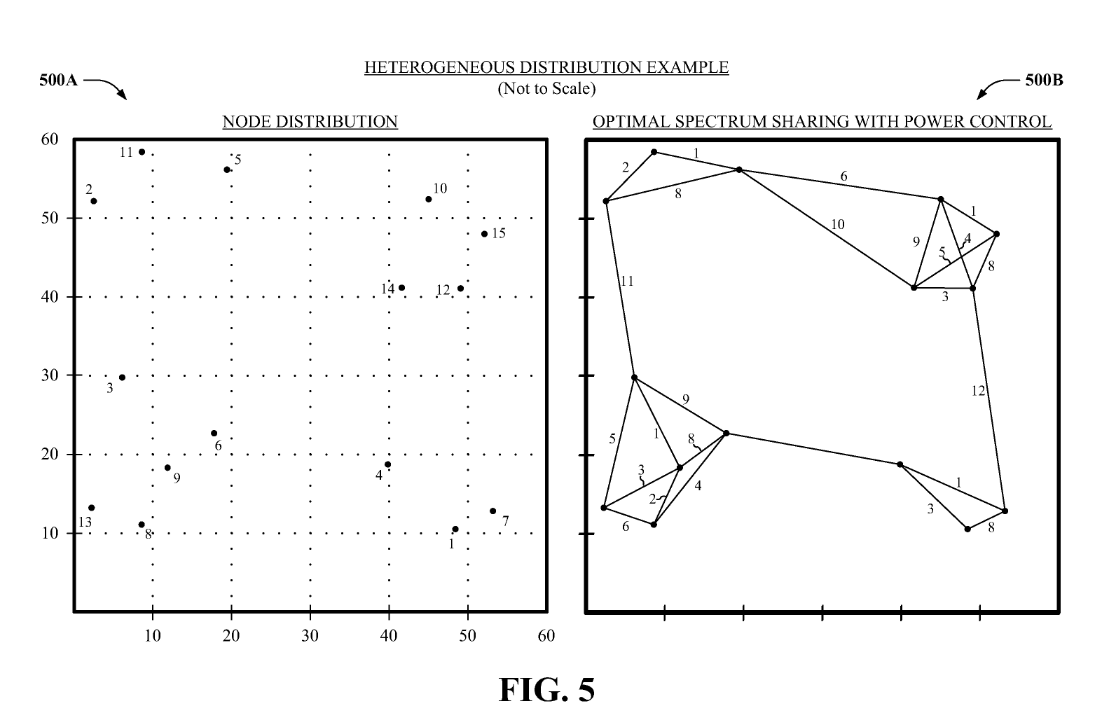

In additional to the qualitative description provided above, a mathematical description of ad-hoc network 104 is provided. The mathematical description is employed in optimizing spectra utilization for various distributions of secondary user nodes 104A-104C in ad-hoc network 104. Examples of these optimizations are given at FIGS. 4 and 5 in conjunction with several constraints, and compared with estimated gains based on spectrum sharing without power control (e.g., where each secondary user node employs maximum transmit power). In addition, Table 1 provides definitions for terminology employed with the mathematical description of ad-hoc network 104, as well as the optimization formulation employed for channel assignments and constraints (e.g., see FIG. 3, infra).

The mathematical description assumes n secondary user nodes in ad-hoc network 104, which comprises M orthogonal channels denoted by a set C having cardinality |C|=M. Respective secondary user nodes can detect available wireless channels, and in at least one aspect of the subject disclosure, it is assumed that a set of available wireless channels observed at each node varies from node to node. In this case, Cᵢ denotes the set of available channels observed by node i, and mᵢ denotes the number of these available channels. Therefore, Cᵢ⊂C and the cardinality |Cᵢ|⊂mᵢ≦M.

Each secondary user i (where 1≦i ≦n) has a programmable number of radio interfaces, denoted by γᵢ. Generally, the radio interface can be tuned to a wide range of channels. However, at a specific time each radio interface can operate on a single channel.

A CR network can be represented by an undirected graph G=(N, E), where N is a set of secondary user nodes (e.g., secondary user nodes 104A-104C) denoted by vertices of the graph, and E is a set of edges between two vertices (e.g., see FIG. 4 at 400B or FIG. 5 at 500B). The set of edges represent potential bi-directional wireless links between nodes of the graph, which are established between each pair of secondary user nodes that are within a maximum transmission range of the respective nodes. The bi-directional links can enable transmission acknowledgments to verify receipt of transmitted data. This enables ad-hoc network 104 to employ networking protocols based on bi-directional links, such as IEEE 802.11 protocols. Thus, if node i can transmit data to node j and vice versa, a potential link is established between nodes i and j, denoted by e:i [symbol] j. Further, Cₑ and δₑ denote the set and the number of available channels for the link e, respectively. As a result, Cₑ=Cᵢ∪Cⱼ, having cardinality |Cₑ|=δₑ.

Further to the above, each secondary user node is assumed to be equipped with an omni-directional antenna and each node's transmitter has power control capability. By adjusting transmit power level, a transmitting node can communicate with receiving nodes at different distances. Therefore, for each pair of transmitting node i and receiving node j there exists a transmission range rᵢⱼ and an interference range Rᵢⱼ. To mitigate interference between wireless links of ad-hoc network 104, a guard range Δ is established, where Rᵢⱼ=(1+Δ)rᵢⱼ . Nodes i and j that are within the interference range Rᵢⱼ can be assigned to different wireless channels, as is discussed in more detail infra.

To ensure bi-directionality, for each bi-directional link e:i [symbol] j, both nodes i and j transmit at the same transmit power. Since physical paths taken by radio waves from node i to node j can typically be reversed, it follows that if two nodes i and j are transmitting at the same power, signals received by node j from node i at this power can also be received by node i if transmitted by node j at the same power. Therefore, for each link e:i [symbol] j, rᵢⱼ=rⱼᵢ, and thus power control can be established for bi-directional link, where nodes participating in that link use the same transmit power.

TABLE 1
Symbol Notations

| Symbol | Definition |
|---|---|
| N | Set of secondary users |
| E | Set of potential bi-directional wireless links |
| G | Ad-hoc network graph |
| C | Set of available wireless channels |
| Cᵢ | Set of available wireless channels at node i |
| Cₑ | Set of available wireless channels at link e |
| N | Number of secondary users \|N\| |
| M | Number of available wireless channels \|C\| |
| mᵢ | Number of available wireless channels at node i, or \|Cᵢ\| |
| γᵢ | Number of radio interfaces at node i |
| δₑ | Number of available channels at link e, or \|Cₑ\| |
| βₑ | Maximum number of channels that can be assigned to link e |
| tᵢ | Minimum number of active links at node i |
| Eᵢ | The set of links incident on node i |
| Iₑ | The set of links that interfere with link e |
| Pᵢⱼ | Transmission power at node i to node j |
| rᵢⱼ | Transmission range at node i to node j |
| Rᵢⱼ | Interference range at node i to node j |
| K | Number of discrete levels of transmission range |
| Δ | Interference guard zone |
| dᵢⱼ | Distance from node i to node j |
| α | Path loss exponent |
| η | Detection power threshold at the receiver |
| F | The set of clusters |
| Aᵢ | The set of nodes belonging to the i-th cluster |
| Bⱼₖ | The set of inter-cluster links between the j-the and k-the clusters |

According to one aspect of the subject disclosure, spectrum optimization can be established assuming static node location. According to additional aspects, the spectrum optimization can assume a set of available channels at each secondary user node is static. This corresponds, for instance, to applications having a slow varying spectrum environment (e.g., broadcast television bands). Based on these assumptions, CR base station 102 acts as a central server for CR applications of secondary user nodes 104A-104C. As described above, each secondary user node can report location and available channel information to CR base station 102, which in turn provides spectrum management and power control for ad-hoc network 104. Spectrum management functionality is discussed in more detail at FIG. 3, infra.

FIG. 2 illustrates a diagram of an example classification 200 for bi-directional wireless links of an ad-hoc network, according to particular aspects of the subject disclosure. Classification 200 comprises a plurality of discrete transmit ranges 204. Each discrete transmit range is associated with a link classification. Thus, a first discrete transmit range, r₁ is associated with a first class, class₁. A second discrete transmit range, r₂ is associated with a second class, class₂, and so on, up to a maximum discrete transmit range r_{K} 202, which is associated with class_{K}, where K is a suitable positive integer.

Further to the above, each class can be implicitly correlated with a predetermined transmit power. As described above at FIG. 1, supra, a particular transmit power can then be assigned implicitly to any bi-directional wireless link falling within a particular class of transmit ranges. Further, a particular bi-directional wireless link can be classified according to distance between nodes participating in the wireless link. This distance is compared with the discrete transmit ranges of classification 200, in order to assign a bi-directional link class and associated transmit power to the particular link. Thus, if the distance between nodes i and j is a distance that falls within discrete transmit range r₄, then a bi-directional wireless link associated with nodes i and j can be assigned a transmit power correlated to class₄.

In one aspect of the subject disclosure, discrete transmission ranges can be evenly divided among the maximum transmission range 200, yielding K discrete levels r_{y} (1≦y≦K), which correspond to transmission power P_{y}, where r_{K} and P_{K} are the maximum transmission range and maximum transmission power, respectively. For even division of transmission ranges and transmission power, the following relations apply:

$$\begin{matrix}{r}_{y} = y \cdot \frac{{r}_{K}}{K} , y = 1 , 2 , K , & ( 1 ) \\ {P}_{y} = η \cdot {y}^{α} \cdot {( \frac{{r}_{K}}{K} )}^{α} , y = 1 , 2 , … , K , & ( 2 )\end{matrix}$$

η is the detection power threshold at a receiver of node i or node j. and α is a path

[symbol]

As stated above at FIG. 1, the set E includes all potential bi-directional wireless links among secondary user nodes in an ad-hoc network (e.g., ad-hoc network 104). As long as a pair of secondary users are within a maximum transmission range r_{K} 202, there exists an edge between the pair. Bi-directional wireless links of the set E are then classified into K classes. As a more specific example, a link e:i [symbol] j is classified as a y-class link if r_{y-1}<dᵢⱼ≦r_{y}. Further, the nodes i and j separated by the distance dᵢⱼ can employ a common transmit power Pᵢⱼ (where P_{ij=P}ⱼᵢ) and the same range rᵢⱼ (rᵢⱼ=rⱼᵢ) to communicate with each other. As a result, Pᵢⱼ=P_{y} and rᵢⱼ=r_{y}.

As is described in more detail at FIG. 3, infra, the power level for each link is not a decision variable, but rather is predefined and implicitly embedded in optimization formulations (e.g., as part of r_{y} and R_{y} for a y-class link). Once potential bi-directional wireless links of set E are classified, and link power level determined there from, the set of links at each node Eᵢ and the set of interfering links for each link Iₑ can be determined. According to particular aspects of the subject disclosure, a BILP formulation (e.g., see equation 4 or 4a) that models efficient spectrum utilization, is solved to establish which link of the set of links E is active, and what channel is assigned to respective links, as well as transmit power assigned for each link.

FIG. 3 illustrates a block diagram of an example CR base station 300 according to particular aspects of the subject disclosure. CR base station 300 comprises a link management component 302. In at least one aspect, link management component 302 can be substantially similar to link management component 108 of FIG. 1, supra. In other aspects, link management component 302 can include some or all of the functionality of link management component 108, in addition to other functionality described below.

As described herein, CR base station 300 receives a set of location information from secondary user nodes served by CR base station 300, as well as available channel information pertaining to respective nodes. This information can be received at a sorting component 308, which identifies potential bi-directional wireless links between secondary user nodes. This identification can comprise, for instance, analyzing the set of location information, and identifying pairs of nodes that are separated by a distance equal to or less than a maximum transmit range of the nodes (e.g., determined from maximum transmit power of transmission equipment available at respective nodes). Sorting component 304 then classifies the potential bi-directional wireless links as a function of distance between pairs of nodes participating in the respective links, and provides the link classes to a reference component 306.

As described herein, reference component 306 correlates classes of wireless links with respective transmit powers. A set of link classification-transmit power correlations can be stored in a data store 310 in a link-transmit power relation file 312. A scheduling component 312 can then utilize the link-transmit power relation file 312 to obtain respective transmit powers for respective bi-directional wireless links, and output the transmit powers in an assignment message. In at least one aspect of the subject disclosure, scheduling component 312 obtains transmit powers for a subset of the potential bi-directional wireless links that are activated by an assignment component 314, as described below.

In general, secondary user nodes have power control capabilities, and a transmitting node can reach a destination node located at different distances by adjusting the transmission power level. In some aspects of the subject disclosure, an assumption that receiving equipment of the secondary user nodes has a common signal detection power threshold, denoted by η. A data transmission is successful, therefore, if the receiving power exceeds the detection power threshold.

For direct communication between secondary user nodes, pairs of nodes must be within maximum transmission range r_{K} of each other, and will tune their respective radio interfaces to a common channel. Those pairs of nodes that are within the maximum transmission range r_{K} are identified as potential bi-directional wireless links by sorting component 304. For data transmission between node i and node j, the following power propagation model for power propagation gain Gᵢⱼ is:

$${G}_{ij} = \frac{1}{{d}_{ij}^{α}}$$

where the power propagation gain is a function of the path loss exponent α. A typical value for α can be between 2 and 4, depending on characteristics of a prevailing communication medium. If node i tranmits data with power Pᵢⱼ to node j, then based on Pᵢⱼ·Gᵢⱼ≧η, the following transmission range and interference ranges are obtained for communication between node i and node j:

$${r}_{ij} = {( \frac{{P}_{ij}}{η} )}^{1 / α} and {R}_{ij} = ( 1 + Δ ) \cdot {( \frac{{P}_{ij}}{η} )}^{1 / α} .$$

Once the distance between nodes i and j [symbol] power class—for nodes i and j gives the following transmit power: Pᵢⱼ=η·rᵢⱼ^{a}.

Because transmit power cannot be continuously adjusted in operation, a quantization approach is utilized to determine respective transmit powers to assign to transmit power classes of wireless links. The quantization approach utilizes a set of discrete transmission ranges for the transmit power classes, resulting in transmission power adjustment also having a set of discrete levels (e.g., see FIG. 2, supra). The set of discrete transmission ranges and discrete power levels is given by equations (1) and (2), above.

In addition to classifying wireless links and determining transmit power levels for those links based on class, link management component 302 can comprise an assignment component 314 for efficient spectrum utilization for an ad-hoc network. Assignment component 314 employs a spectrum sharing algorithm to efficiently allocate wireless channels among a subset of the potential bi-directional wireless links. The spectrum sharing algorithm is configured to maximize channel reuse, within a set of constraints provided by a constraint component 316. In at least one aspect of the subject disclosure, the set of constraints can be configurable, e.g., to meet changing wireless conditions, dynamic secondary user node conditions, or the like. In other aspects, the set of constraints can be static. Channel assignments provided by assignment component 314 can be output by link management component 302 along with transmit power assignments by scheduling component 312, in an assignment message.

A potential bi-directional wireless link becomes activated, upon being assigned a wireless channel by assignment component 314. Expressed differently, link e is active upon being assigned some channel m. A 0-1 binary variable can be defined to represent the active/inactive state of wireless links:

$${x}_{e}^{m} = \{ \begin{matrix}1 & if link e is active on channel m \\ 0 & otherwise .\end{matrix} \qquad ( 3 )$$

Because links are bi-directional, both the sending node and receiving node should be free from interference for successful transmission. Interference for bi-directional links can be modeled as follows: let e denote a link between nodes i and j, and e′ denote another link between nodes k and h. The transmission on link e is successful if the following conditions are satisfied:

(i) the distance between nodes i and j is no more than the transmission range, said differently: d_{ab}≦r_{ab} for ab=ij,ji.

(ii) For any link e′:k [symbol] h being assigned a same wireless channel as link e:i [symbol] j, the receiving nodes i and j are outside of the interference range, _{said differently: d}_{ab}>Rₖₕ for ab=ki, kj and d_{ab}>Rₕₖ for ab=hi, hj. Note that requirement (ii) implicitly includes the cases where link e and link e′ have a node in common (e.g., where i=k or i=h, or j=k or j=h).

Additionally, Eᵢ is defined as the set of potential bi-directional wireless links incident on node i, and Iₑ is defined as the set of links which interfere with link e. The following relations then exist for this bi-directional interference model:

Eᵢ={i [symbol] j:dᵢⱼ23 rᵢⱼ}∩{i [symbol] j:dᵢⱼ≦rⱼᵢ},

Iₑ={e′:dₖᵢ≦Rₖₕ}∪{e′:dₖⱼ≦Rₖₕ}∪{e′:dₕᵢ≦Rₕₖ}∪{e′:dₕⱼ≧Rₕₖ}

Additionally, this interference model results in rᵢⱼ=rⱼᵢ, and Rₖₕ=Rₕₖ. Thus, for any pair of sending and receiving secondary user nodes, the sending node and receiving node transmit at the same transmit power. This ensures the bi-directionality of the link e:i [symbol] j.

Assignment component 314 employs an optimization algorithm that is configured to maximize total spectral utilization. This spectral utilization can be subject to one or more constraints, such as an interference constraint, imposed by constraint component 316. In one aspect of the subject disclosure, maximization of total spectral utilization can be defined by maximum channel reuse. In this aspect, the total spectral utilization can be based on the total number of active links for an ad-hoc network. However, in other aspects of the subject disclosure, the maximum spectral utilization can involve maximizing bandwidth utilization, or the like, or a suitable combination thereof. The optimization algorithm for maximizing the number of links can be expressed as follows:

$$max {\sum }_{e ∈ E} {\sum }_{m ∈ {C}_{e}} {x}_{e}^{m} \qquad ( 4 )$$

Equation (4) therefore seeks to maximize the total number of active links for an ad-hoc network of secondary user nodes. The optimization algorithm for maximizing total bandwidth can be expressed as follows:

$$max {\sum }_{e ∈ E} {\sum }_{m ∈ {C}_{e}} {x}_{e}^{m} \cdot {B}_{e}^{m} \qquad ( 4 a )$$

where Bₑ^{m} denotes the bandwidth for channel m at link e. (Note that Bₑ^{m} can be heterogeneous or homogeneous, where heterogeneous means the bandwidth is link-dependent or channel-dependent).

Constraint component 316 can reference various constraint definitions and rules for applying constraints on the optimization algorithm, stored in data store 308, at constraint definitions file 318. The constraints affect the optimization algorithm employed by assignment component 314, and can mathematically model effects of wireless conditions (e.g., an interference model), limitations of the secondary user nodes (e.g., a maximum number of radio interfaces), or other physical limitations or desired limits on channel allocation. In one aspect of the subject disclosure, an interference constraint is imposed, based on the bi-directional interference model described above. This model assumes that significant interference occurs only among links sharing the same wireless channel. Accordingly, one example interference constraint establishes that if link e is active on channel m, then channel m is not assigned to any link e′ as long as e′εIₑ. In this example, the interference constraint can be expressed as:

xₑ^{m}+x_{e′}^{m}≦1(mεCₑ∩C_{e′},e′εIₑ,eεE) (5)

[symbol]

constraint on the optimization algorithm. Depending on transceiver equipment employed, it can be possible for a pair of secondary user nodes to have multiple links between them. This can occur, for instance, where the number of radio interfaces at respective ones of the pair of nodes permits communication on multiple channels. In this case, the link-channel constraint restricts the optimization algorithm to assigning no more than βₑ wireless channels to the pair of nodes (where βₑ≦δₑ). This leads to the following expression:

$${\sum }_{m ∈ {C}_{e}} {x}_{e}^{m} \leq {β}_{e} ( e ∈ E ) . \qquad ( 6 )$$

In still other aspects of the subject disclosure, the one or more constraints imposed by constraint component 314 can include a node-interface constraint. This node-interface constraint can limit a number of bi-directional wireless links that are active for a particular node. Generally, a node can establish multiple links with neighboring nodes, depending on whether it can tune its radio interface to a different channel(s). The number of links is constrained by the number of radio interfaces for the particular node. Therefore, constraint component 316 can impose the following constraint on the optimization algorithm to model this radio interface limitation of secondary user nodes:

$${\sum }_{e ∈ {E}_{i}} {\sum }_{m ∈ {C}_{e}} {x}_{e}^{m} \leq {γ}_{i} ( i ∈ N ) . \qquad ( 7 )$$

In yet other aspects of the subject disclosure, the one or more constraints can comprise a node connectivity constraint. This node connectivity constraint can establish a minimum number tᵢ of active bi-directional wireless links for a particular node (e.g., where tᵢ≧1). This constraint can be expressed as follows:

$${\sum }_{e ∈ {E}_{i}} {\sum }_{m ∈ {C}_{e}} {x}_{e}^{m} \geq ( i ∈ N ) . \qquad ( 8 )$$

It should be appreciated that the foregoing constraints are not exhaustive. Particularly, other linear constraints can be imposed on optimization algorithm (4) or (4a) where desired. In at least one aspect of the subject disclosure, constraint component 316 can impose an inter-cluster connectivity constraint, for instance where link management component 302 identifies suitable clusters of secondary user nodes, from the location information reported by the user nodes (e.g., see FIG. 5, infra, at 500A). In such case, the following constraint can be employed:

$${\sum }_{e ∈ {B}_{jk}} {\sum }_{m ∈ {C}_{e}} {x}_{e}^{m} \geq 1 ( {B}_{jk} \neq 0 , k > j , k ∈ F , j ∈ F ) \qquad ( 9 )$$

As written, equation (9) is configured to constrain channel assignments such that most intra-cluster communication is at a lower power level, and higher power is used for inter-cluster links.

FIG. 4 illustrates a block diagram of an example distribution 400A of secondary user nodes, and an example optimal spectrum allocation graph 400B for the distribution 400A, according to particular aspects of the subject disclosure. Example distribution 400A employs 15 secondary user nodes in a 60×60 area. Particularly, distribution 400A comprises a homogeneous distribution of the 15 secondary user nodes (note that distribution 400A is not drawn to scale). Additionally, for this example, twelve wireless channels exist for wireless communication. The maximum transmit range of each of the secondary user nodes is substantially similar, and for this example assumed to be r_{K}=30. Further, each node has 6 discrete levels of transmission range, corresponding to 5, 10, 15, 20, 25 and 30, respectively. The notation, symbols and parameter settings for the homogeneous distribution (as well as heterogeneous distribution 500A of FIG. 5, infra) are given by Table 2. In addition, the location and set of available channels (randomly generated) for homogeneous distribution 400A are given by Table 3.

TABLE 2
Notations and Parameter Settings for FIGS. 4 and 5

| Symbol | Definition | Values |
|---|---|---|
| A² | Deployment area | (60 m)² |
| M | Number of channels in the network | 12 |
| N | Number of secondary users | 15 |
| Bₑ | Maximum number of channels assigned to link e | 1 |
| γᵢ | Number of radio interfaces at node i | 4 |
| tᵢ | Minimum number of active links at node i | 2 |
| K | Number of discrete levels of transmission range | 6 |
| r_{K} | Maximum transmission range | 30 |
| R_{K} | Maximum interference range | 45 |
| Δ | Guard zone | 0.5 |

TABLE 3
Homogeneous Distribution 400A Node Locations and Available Channels

| Node Index | Location | Available Channels |
|---|---|---|
| 1 | (48.5, 4.6) | 1, 3, 4, 6, 8 |
| 2 | (18.1, 55.3) | 4, 7, 11 |
| 3 | (2.5, 29.7) | 1, 2, 5, 6, 12 |
| 4 | (45.3, 20.5) | 1, 4, 5, 8, 10 |
| 5 | (19.4, 36.7) | 3, 5, 8, 9, 10, 11 |
| 6 | (24.9, 24.7) | 2, 3, 5, 7, 9, 10 |
| 7 | (35.3, 32.8) | 1, 2, 6, 7, 9, 12 |
| 8 | (20.3, 1.2) | 2, 4, 6, 11, 12 |
| 9 | (11.8, 13.4) | 2, 4, 5, 6, 7, 11 |
| 10 | (56.5, 34.2) | 3, 6, 9, 11 |
| 11 | (8.7, 58.3) | 1, 5, 7, 8 |
| 12 | (42.0, 51.3) | 2, 4, 8, 10, 12 |
| 13 | (2.3, 13.5) | 2, 3, 6, 8, 12 |
| 14 | (51.7, 51.3) | 1, 7, 9, 10, 11 |
| 15 | (32.1, 57.9) | 4, 5, 8 |

Spectrum allocation graph 400B depicts the activated bi-directional wireless links for homogeneous distribution of secondary user nodes 400A. Each secondary user node of graph 400B is depicted by a point (matching the secondary user node points of distribution 400A), and edges between pairs of points depict activated bi-directional wireless links. Activated bi-directional wireless links are obtained from optimization algorithm (equation 4), supra, constrained by equations (5), (6), (7), and (8). Table 4 identifies the activated links for graph 400B, and the assigned power level, determined from the discrete transmission ranges associated with the respective activated links. Without power control, each secondary user node transmits at maximum power P_{K} (power level 6). As a result, interference among pairs of nodes causes interference constraint (5) to restrict the optimization algorithm to activating only 14 wireless links. With the implicit power control described herein, interference among pairs of secondary user nodes is reduced for graph 400B. As shown in Table 4, there are three links employing power level 2, four links employing power level 3, seven links employing power level 4, two links employing power level 5 and two links employing power level 6. This reduction in interference enables the optimization algorithm to activate 18 links, improving spectrum utilization by 28.6%.

TABLE 4
Power Level of Activated Links for FIG. 400B

| Link Index | Link Nodes | Power Level |
|---|---|---|
| 1 | 2 [symbol] 11 | 2 |
| 2 | 9 [symbol] 13 | 2 |
| 3 | 12 [symbol] 14 | 2 |
| 4 | 5 [symbol] 6 | 3 |
| 5 | 6 [symbol] 7 | 3 |
| 6 | 8 [symbol] 9 | 3 |
| 7 | 12 [symbol] 15 | 3 |
| 8 | 1 [symbol] 4 | 4 |
| 9 | 2 [symbol] 5 | 4 |
| 10 | 3 [symbol] 9 | 4 |
| 11 | 3 [symbol] 13 | 4 |
| 12 | 4 [symbol] 7 | 4 |
| 13 | 7 [symbol] 12 | 4 |
| 14 | 10 [symbol] 14 | 4 |
| 15 | 7 [symbol] 10 | 5 |
| 16 | 11 [symbol] 15 | 5 |
| 17 | 1 [symbol] 8 | 6 |
| 18 | 6 [symbol] 13 | 6 |

Referring now to FIG. 5, there is depicted a heterogeneous distribution 500A of secondary user nodes and optimization graph 500B, according to still other aspects of the subject disclosure. Similar to homogeneous distribution 400A, heterogeneous distribution 500A includes 15 secondary user nodes in a 60×60 area, comprises a total of 12 wireless channels in the system (where availability of the wireless channels at respective nodes is randomly generated), 6 discrete link classifications and 6 corresponding transmit power levels that corresponds with 6 discrete levels of transmission range, corresponding to 5, 10, 15, 20, 25 and 30, respectively. Table 5 provides the location and available channels for respective nodes of distribution 500A.

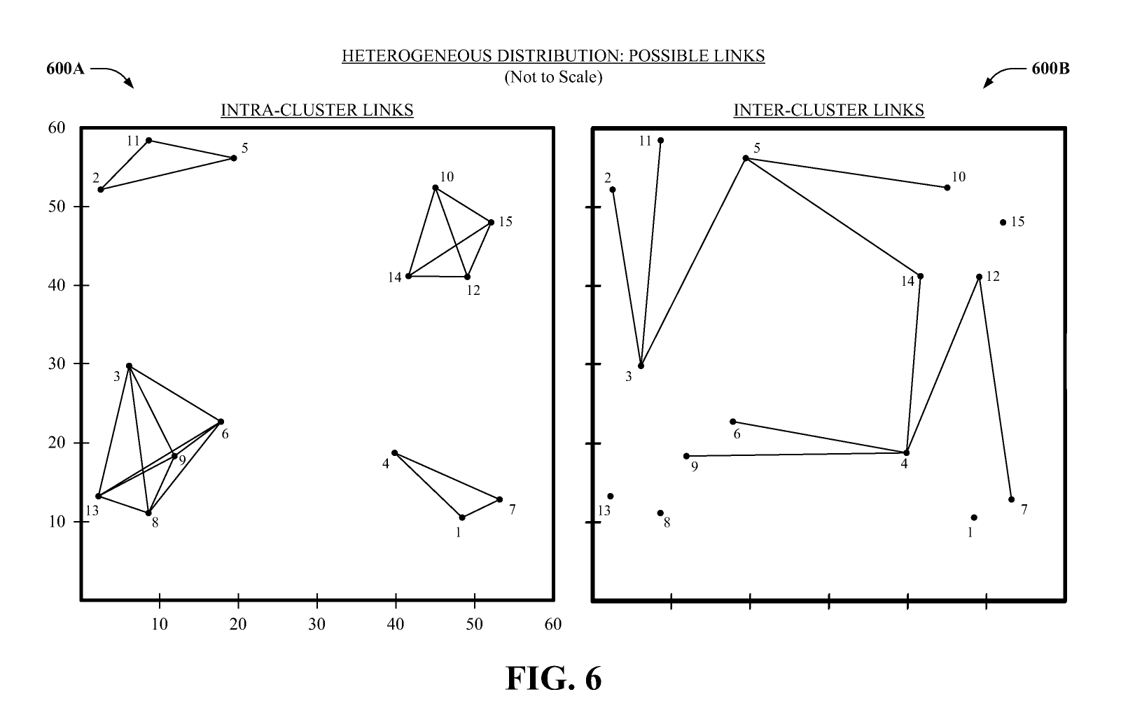

Different from the homogeneous example, node clustering is implemented for the heterogeneous example. Clustering involves grouping subsets of secondary user nodes into clusters, having a hierarchy that can be as deep as the number of power levels. In this example, the secondary user nodes of heterogeneous distribution 400A are clustered into four 20 m clusters. FIG. 6 depicts intra-cluster wireless links at 600A, and inter-cluster wireless links at 600B. The intra-cluster wireless links 600A include the set of activated links having a link length of less than or equal to 20. Inter-cluster wireless links 600B include the set of activated links having a link length of greater than 20 but less than 30. If F denotes the set of clusters, Aᵢ denotes the set of nodes belonging to the i-th cluster, and Bⱼₖ denotes the inter-cluster links of 600B between the j-th and the k-th clusters (Bⱼₖ=Bₖⱼ. For the case of four clusters, F={1, 2, 3, 4}, and for the heterogeneous distribution 500A, A₁={2, 5, 11}, A₂={3, 6, 8, 9, 13}, A₃={1, 4, 7}, and A₄={10, 12, 14, 15}. In addition, B₁₂={3 [symbol] 2, 3 [symbol] 11, 3 [symbol] 5}, B₁₄={5 [symbol] 10, 5 [symbol] 14}, B₂₃={4 [symbol] 6, 4 [symbol] 9} and B₃₄={4 [symbol] 12, 4 [symbol] 14, 7 [symbol] 12}.

TABLE 5
Heterogeneous Distribution 500A Node Locations and Available Channels

| Node Index | Location | Available Channels |
|---|---|---|
| 1 | (48.5, 10.6) | 1, 3, 4, 6, 8, 10, 11 |
| 2 | (2.8, 52.3) | 2, 3, 4, 7, 8, 9, 11 |
| 3 | (6.4, 29.7) | 1, 2, 5, 6, 9, 11, 12 |
| 4 | (39.6, 18.5) | 1, 3, 4, 5, 7, 8, 10, 12 |
| 5 | (19.4, 56.1) | 1, 3, 5, 6, 7, 8, 10, 11 |
| 6 | (17.8, 22.7) | 2, 3, 4, 5, 7, 8, 9, 10 |
| 7 | (53.3, 12.8) | 1, 2, 6, 7, 8, 9, 12 |
| 8 | (8.6, 11.2) | 1, 2, 4, 6, 9, 11, 12 |
| 9 | (11.8, 18.4) | 1, 2, 3, 4, 6, 8, 9, 11 |
| 10 | (45.1, 52.4) | 1, 3, 4, 6, 9, 10, 11 |
| 11 | (8.7, 58.3) | 1, 2, 5, 7, 8, 9, 12 |
| 12 | (49.0, 41.3) | 2, 3, 4, 6, 8, 10, 12 |
| 13 | (2.3, 13.5) | 2, 3, 5, 6, 8, 9, 12 |
| 14 | (41.7, 41.3) | 1, 3, 4, 5, 7, 9, 10, 11 |
| 15 | (52.1, 47.9) | 1, 3, 4, 5, 8, 9, 12 |

Optimization graph 500B depicts the secondary user nodes from heterogeneous distribution 500A, and activated wireless links assigned to these nodes from optimization algorithm (4), supra. Note that equation (4) maximizes the number of activated wireless links, subject to constraints (5), (6), (7), (8) and (9), to increase reuse of wireless channels. As long as a channel is assigned to a link, the BILP formulation of equation (4) increases by one. With power control, a short link uses a smaller power level and incurs a shorter interference range, compared with a long link. As a result, a short link will have more chances to be assigned a wireless channel. In the heterogeneous scenario, establishing an inter-cluster link is important to provide connectivity between the clusters. Accordingly, equation (9) is an inter-cluster connectivity constraint imposed on optimization algorithm equation (4).

As can be seen by the graph of intra-cluster wireless links 600A, the joint power control and clustering of equations (4) through (9) results in assignment of wireless channels such that most intra-cluster communication is at a lower power level. In contrast, inter-cluster communication is typically at higher power level. Table 6 depicts the nodes participating in heterogeneous links of graph 500B, and transmit powers assigned to respective links. It is worth noting that graph 500B includes 25 active links. Moreover, among the 25 active links, there are eight links assigned to power level 2, ten links assigned to power level 3, two links assigned to power level 4, two links assigned to power level 5, and three links assigned to power level 6. Without power control (e.g., all nodes transmit at maximum power P_{K}), interference constraints limit equation (4) from activating more than 16 wireless links. With power control, however, power level 2 is assigned to any link having length within (5, 10], power level 3 is assigned to any link having length within (10, 15], and so on. Because there are many relatively short links in heterogeneous distribution 500A due to the clustering structure, power control significantly improves spectrum sharing efficiency. In this example, power control improves spectrum utilization by 56.3%.

TABLE 6
Power Level of Activated Links for FIG. 500B

| Link Index | Link Nodes | Power Level |
|---|---|---|
| 1 | 1 [symbol] 7 | 2 |
| 2 | 2 [symbol] 11 | 2 |
| 3 | 6 [symbol] 9 | 2 |
| 4 | 8 [symbol] 9 | 2 |
| 5 | 8 [symbol] 13 | 2 |
| 6 | 10 [symbol] 15 | 2 |
| 7 | 12 [symbol] 14 | 2 |
| 8 | 12 [symbol] 15 | 2 |
| 9 | 1 [symbol] 4 | 3 |
| 10 | 3 [symbol] 6 | 3 |
| 11 | 3 [symbol] 9 | 3 |
| 12 | 4 [symbol] 7 | 3 |
| 13 | 5 [symbol] 11 | 3 |
| 14 | 6 [symbol] 8 | 3 |
| 15 | 9 [symbol] 13 | 3 |
| 16 | 10 [symbol] 12 | 3 |
| 17 | 10 [symbol] 14 | 3 |
| 18 | 14 [symbol] 15 | 3 |
| 19 | 2 [symbol] 5 | 4 |
| 20 | 3 [symbol] 13 | 4 |
| 21 | 2 [symbol] 3 | 5 |
| 22 | 4 [symbol] 6 | 5 |
| 23 | 5 [symbol] 10 | 6 |
| 24 | 5 [symbol] 14 | 6 |
| 25 | 7 [symbol] 12 | 6 |

The aforementioned systems have been described with respect to interaction between several components and/or wireless communication entities. It should be appreciated that such systems and components can include those components or sub-components specified therein, some of the specified components or sub-components, and/or additional components. For example, a system could include CR base station 102, link management component 302, primary user equipment 106 and ad-hoc network 104A-104C, or a different combination of these or other entities. Sub-components could also be implemented as modules communicatively coupled to other modules rather than included within parent modules. Additionally, it should be noted that one or more components could be combined into a single component providing aggregate functionality. For instance, reference component 306 can include scheduling component 312, or vice versa, to facilitate correlating discrete transmit powers to discrete classifications of wireless links and assigning transmit powers to particular activated links, by way of a single component. The components can also interact with one or more other components not specifically described herein but known by those of skill in the art.

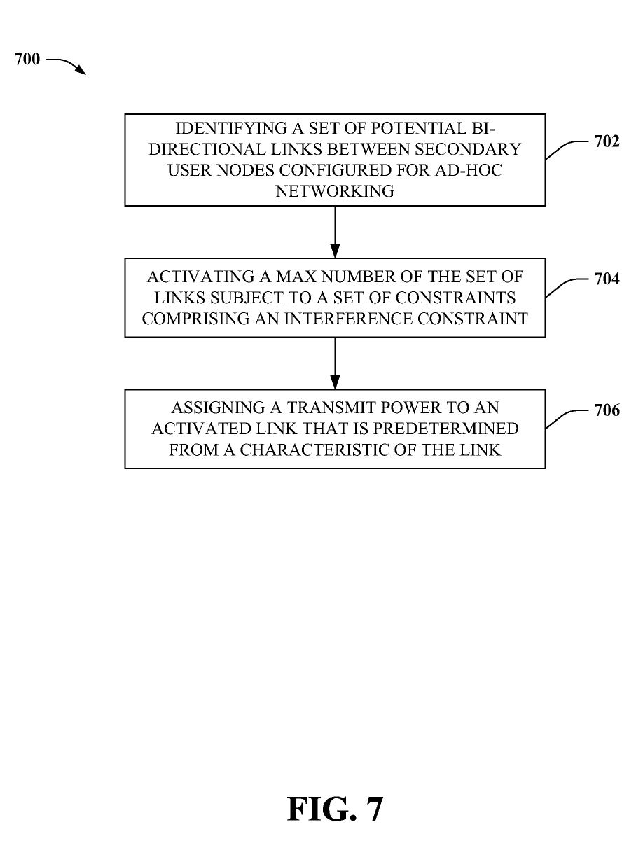

FIGS. 7, 8, and 9 illustrate various methods in accordance with one or more of the various embodiments disclosed herein. While, for purposes of simplicity of explanation, the methods are shown and described as a series of acts, it is to be understood and appreciated that the various embodiments are not limited by the order of acts, as some acts may occur in different orders and/or concurrently with other acts from that shown and described herein. For example, those skilled in the art will understand and appreciate that a method could alternatively be represented as a series of interrelated states or events, such as in a state diagram. Moreover, not all illustrated acts may be required to implement a method in accordance with the various embodiments. Additionally, it should be further appreciated that the methods disclosed hereinafter and throughout this specification are capable of being stored on an article of manufacture to facilitate transporting and transferring such methods to computers. The term article of manufacture, as used herein, is intended to encompass a computer program accessible from any computer-readable device, carrier, or media.

FIG. 7 illustrates a flowchart of a sample method 700 for providing implicit power control in conjunction with efficient spectrum allocation for CR wireless communications, according to one or more aspects of the subject disclosure. At 702, method 700 can comprise identifying a set of potential bi-directional links between secondary user nodes that are configured for ad-hoc networking These potential bi-directional links can be determined between pairs of secondary user nodes that are separated by a distance less than or equal to a maximum transmission range of the nodes.

At 704, method 700 can comprise activating a maximum number of the set of potential bi-directional links subset to a set of constraints. Particularly, the set of constraints can comprise at least an interference constraint. In particular aspects, the set of constraints can additionally comprise one or more of a node-interface constraint, a link-channel constraint, a node connectivity constraint, or an inter-cluster connectivity constraint. Further, at 706, method 700 can comprise assigning a transmit power to an activated bi-directional link that is predetermined from a characteristic of the activated bi-directional link. According to particular aspects, the characteristic of the activated bi-directional link can comprise a length of the link, and assigning transmit power to activated links can further comprise comparing a length of a particular link to a classification of link lengths, and assigning a transmit power to the particular link that is correlated to the class of link lengths that encompasses the length of the particular link.

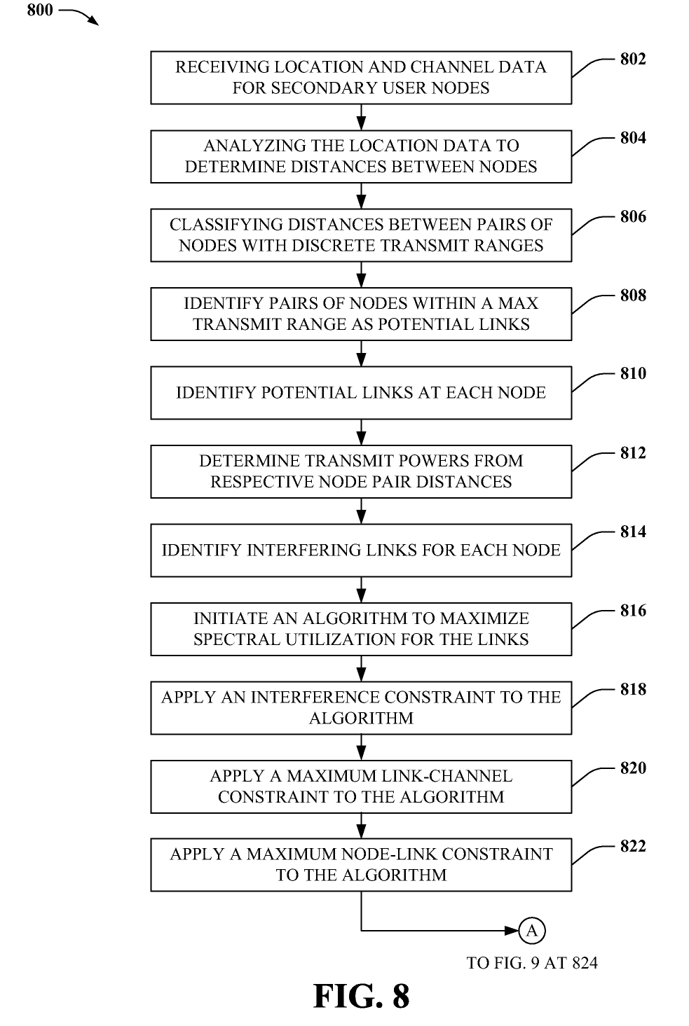

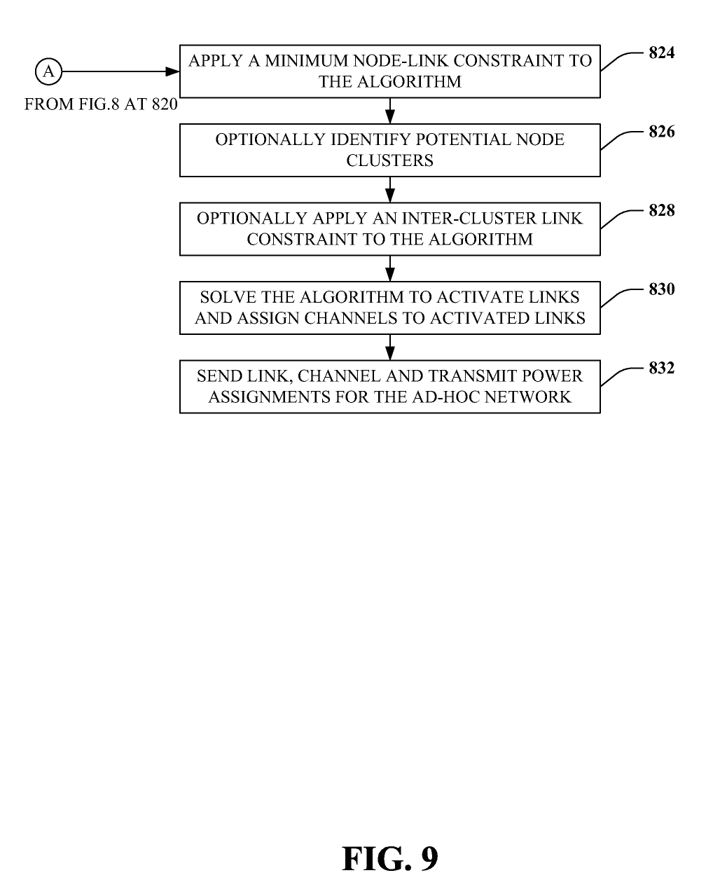

FIGS. 8 and 9 illustrate a flowchart of a sample method for providing efficient spectrum allocation for an ad-hoc network, incorporating implicit power control assignments according to additional aspects. At 802, method 800 can comprise receiving node location and available channel data from secondary user nodes participating in an ad-hoc network. At 804, method 800 can comprise analyzing the location data to determine distances between secondary user nodes. At 806, method 800 can comprise classifying distances between pairs of nodes according to discrete transmit ranges. At 808, method 800 can comprise identifying pairs of nodes within a maximum transmit range as potential bi-directional links. At 810, method 800 can comprise identifying potential bi-directional links at respective nodes. At 812, method 800 can comprise determining transmit powers for respective bi-directional links from distance classifications, and discrete transmit powers assigned to respective classifications.

At 814, method 800 can comprise identifying respective sets of interfering links for each secondary user node. At 816, method 800 can comprise initiating an algorithm to maximize spectral utilization for the set of bi-directional links. At 818, method 800 can comprise applying an interference constraint to the algorithm. At 820, method 800 can comprise applying a maximum link-channel constraint to the algorithm. At 822, method 800 can comprise applying a maximum node-link constraint to the algorithm. Method 800 proceeds from 822 to 824 at FIG. 9.

Referring to FIG. 9, method 800 continues at 824, where method 800 can comprise applying a minimum node-link constraint to the algorithm initiated at reference number 816. At 826, method 800 can comprise optionally identifying suitable clusters of subsets of the secondary user nodes. In at least one aspect, a cluster can comprise those secondary user nodes within a predetermined cluster distances of one or more other nodes. Furthermore, at 828, method 800 can comprise optionally applying an inter-cluster link constraint to the algorithm.

At 830, method 800 can comprise solving the algorithm to activate bi-directional links and assign wireless channels to respective activated links. In one aspect, the algorithm reuses wireless channels for multiple wireless links having respective node pairs that are outside of an interference range. In a further aspect, the algorithm assigns different wireless channels to two wireless links having respective pairs of nodes, wherein at least one node of one of the pairs of nodes is within the interference range of at least one node of a second of the pair of nodes. At 832, method 800 can comprise sending link, channel and transmit power assignments for utilization by secondary nodes of the ad-hoc network.

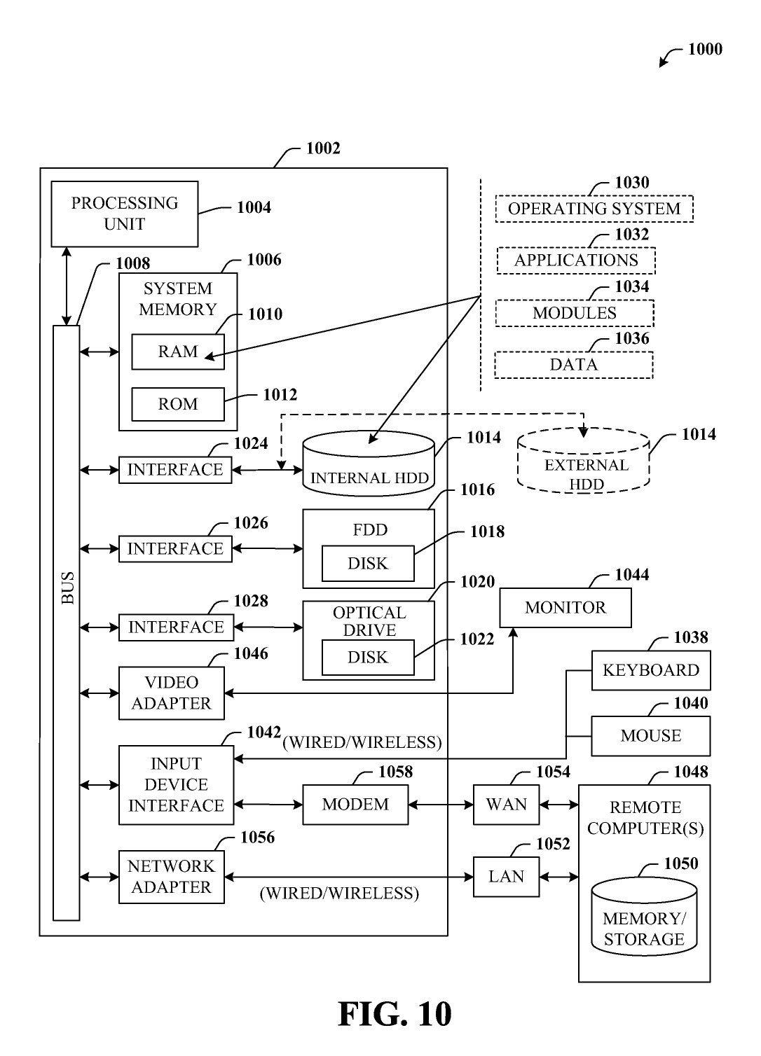

Referring now to FIG. 10, there is illustrated a block diagram of an exemplary computer system operable to execute aspects of the disclosed subject matter. In order to provide additional context for various aspects of the various embodiments, FIG. 10 and the following discussion are intended to provide a brief, general description of a suitable computing environment 1000 in which the various aspects of the various embodiments can be implemented. Additionally, while the various embodiments described above may be suitable for application in the general context of computer-executable instructions that may run on one or more computers, those skilled in the art will recognize that the various embodiments also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the various embodiments may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Continuing to reference FIG. 10, the exemplary environment 1000 for implementing various aspects of one or more of the various embodiments includes a computer 1002, the computer 1002 including a processing unit 1004, a system memory 1006 and a system bus 1008. The system bus 1008 couples to system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 may also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE1394 interface technologies. Other external drive connection technologies are within contemplation of the subject matter claimed herein.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the various embodiments.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the various embodiments can be implemented with various commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 may operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which may connect to a global communications network, e.g., the Internet.

When used in a LAN networking environment, the computer 1002 is connected to the local network 1052 through a wired and/or wireless communication network interface or adapter 1056. The adapter 1056 may facilitate wired or wireless communication to the LAN 1052, which may also include a wireless access point disposed thereon for communicating with the wireless adapter 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE802.11 (a, b, g, n, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 5 GHz radio bands, at an 11Mbps (802.11a) or 54 Mbps (802.11b) data rate, for example, or with products that contain both bands (dual band), so the networks can provide real-world performance similar to the basic 10BaseT wired Ethernet networks used in many offices.

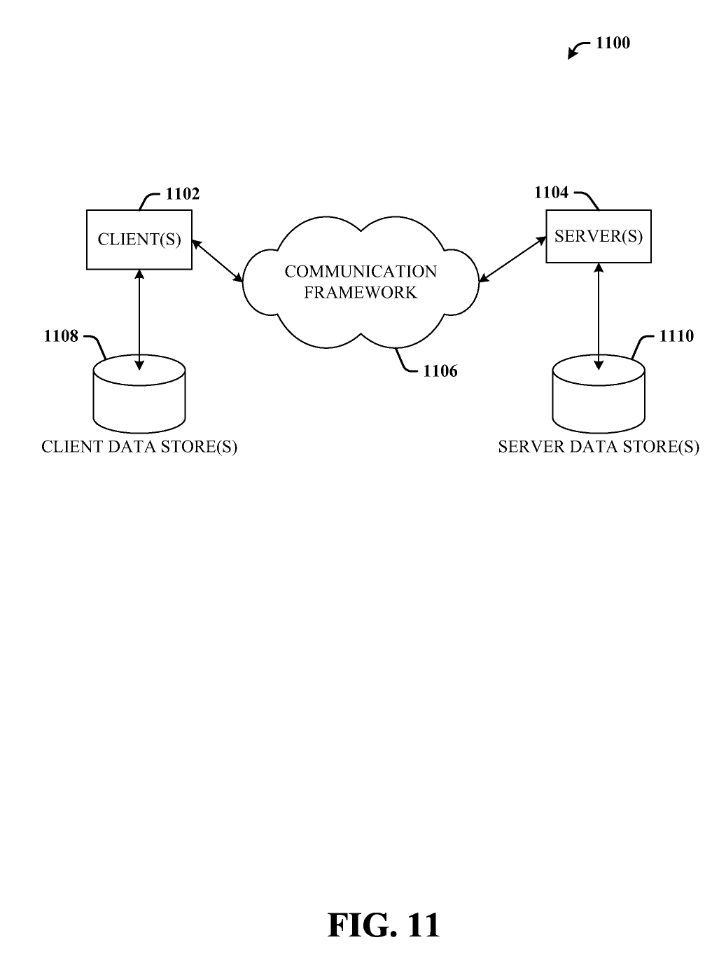

Referring now to FIG. 11, there is illustrated a schematic block diagram of an exemplary computer compilation system operable to execute the disclosed architecture. The system 1100 includes one or more client(s) 1102. The client(s) 1102 can be hardware and/or software (e.g., threads, processes, computing devices). The client(s) 1102 can house cookie(s) and/or associated contextual information by employing the various embodiments, for example.

The system 1100 also includes one or more server(s) 1104. The server(s) 1104 can also be hardware and/or software (e.g., threads, processes, computing devices). The servers 1104 can house threads to perform transformations by employing the various embodiments, for example. One possible communication between a client 1102 and a server 1104 can be in the form of a data packet adapted to be transmitted between two or more computer processes. The data packet may include a cookie and/or associated contextual information, for example. The system 1100 includes a communication framework 1106 (e.g., a global communication network such as the Internet) that can be employed to facilitate communications between the client(s) 1102 and the server(s) 1104.

Communications can be facilitated via a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

What has been described above includes examples of the various embodiments. It is, of course, not possible to describe every conceivable combination of components or methods for purposes of describing the embodiments, but one of ordinary skill in the art may recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments. In this regard, it will also be recognized that the embodiments includes a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system for cognitive radio wireless communication, comprising:
a sorting component configured to classify respective bi-directional wireless links formed by a set of secondary user nodes operating as an ad-hoc network in a cognitive radio arrangement;
a reference component configured to correlate a node transmit power with a class of a bi-directional wireless link of the respective bi-directional wireless links; and
a scheduling component configured to assign the node transmit power to participating nodes of the set of secondary user nodes that participate in the bi-directional wireless link according to the class of the bi-directional wireless link.

2. The system of claim 1, wherein the sorting component is further configured to classify the respective bi-directional wireless links as a function of respective distances between respective participating nodes participating in the respective bi-directional wireless links.

3. The system of claim 2, wherein the sorting component is further configured to establish a set of classes for classifying the respective bi-directional wireless links, wherein respective classes of the set of classes are defined by respective ranges of distances between associated participating nodes.

4. The system of claim 2, wherein the reference component is configured to assign respective node transmit powers to respective ranges of distances between the respective participating nodes.

5. The system of claim 1, wherein the scheduling component is configured to determine node transmit power assignments implicitly from classes of the respective bi-directional wireless links.

6. The system of claim 1, wherein the secondary user nodes employ link level acknowledgment as part of the ad-hoc network.

7. The system of claim 1, further comprising:
a binary integer linear programming component configured to balance available spectra among the participating nodes.

8. The system of claim 7, wherein the binary integer linear programming component is employed to activate the bi-directional wireless link between the participating nodes, or to assign an available wireless channel to the bi-directional wireless link.

9. The system of claim 1, further comprising a constraint component configured to establish one or more constraints for the respective bi-directional wireless links of the ad-hoc network, wherein at least a subset of the constraints are configured to increase a number of active bi-directional wireless links established for the ad-hoc network.

10. The system of claim 9, wherein the one or more constraints include an interference constraint that limits assignment of a wireless channel to more than one of the respective bi-directional wireless links.

11. The system of claim 9, wherein the one or more constraints include a link-channel constraint that limits a number of wireless channels assigned to the bi-directional wireless link.

12. The system of claim 9, wherein the one or more constraints include a node interface constraint that limits a number of bi-directional wireless links that are active for a single node, based on a number of radio interfaces available for the single node.

13. The system of claim 9, wherein the one or more constraints include a node connectivity constraint that requires establishment of one or more bi-directional wireless links at a single node.

14. The system of claim 9, wherein subsets of the set of secondary user nodes form a plurality of node clusters, and further wherein the one or more constraints include an inter-cluster connectivity constraint that establishes at least one bi-directional wireless link between at least two nodes associated with respective ones of the plurality of node clusters.

15. The system of claim 1, further comprising an assignment component configured to schedule available wireless channels to the respective bi-directional wireless links.

16. The system of claim 15, wherein the available wireless channels are identified dynamically by respective secondary user nodes of the set, and reported in response to being identified.

17. A method of cognitive radio wireless communication, comprising:
identifying a set of potential bi-directional links between secondary user nodes that are configured for ad-hoc networking;
activating a maximum number of the set of potential bi-directional links subject to a set of constraints, wherein the set of constraints comprises at least an interference constraint; and
assigning a transmit power to an activated bi-directional link that is implicitly determined from a characteristic of the activated bi-directional link.

18. The method of claim 17, further comprising receiving location information or available channel information pertaining to the secondary user nodes.

19. The method of claim 18, further comprising analyzing the location information and deriving the characteristic of the activated bi-directional link from the location information.

20. The method of claim 19, further comprising determining a distance between nodes participating in the activated bi-directional link and determining the characteristic of the link from the distance, and determining the transmit power based on the distance.

21. The method of claim 20, further comprising activating a subset of the potential bi-directional links that comprise a pair of nodes within a maximum transmit range and that satisfy the set of constraints.

22. The method of claim 17, further comprising:
maximizing wireless channel reuse for activated bi-directional wireless links; or
maximizing wireless bandwidth reuse for activated bi-directional wireless links.

23. The method of claim 22, wherein maximizing wireless channel reuse further comprises assigning a wireless channel to a plurality of activated bi-directional links having respective pairs of nodes that are separated by a distance that is equal to or greater than a largest of the respective interference ranges associated with the pairs of nodes.

24. The method of claim 22, further comprising:
based on an interference constraint, assigning separate wireless channels to a pair of activated links where a node of a first of the pair of activated links and a node of a second of the pair of activated links are separated by a distance that is less than a larger of the interference ranges associated with the first link and the second link.

25. The method of claim 17, further comprising establishing a set of discrete and mutually exclusive transmit ranges and assigning a transmit range of the set of transmit ranges to the activated bi-directional link based on distance between respective nodes participating in the activated bi-directional link.

26. The method of claim 17, further comprising imposing a link channel constraint that maximizes a number of wireless channels assigned to the activated bi-directional link.

27. The method of claim 17, further comprising imposing a node radio constraint that limits a number of wireless channels assigned to the activated bi-directional link to the smallest number of programmable radio interfaces employed by nodes participating in the activated link.

28. The method of claim 17, further comprising imposing a node connectivity constraint that establishes a minimum number of active links for one or more secondary user nodes.

29. The method of claim 17, further comprising identifying one or more clusters of the secondary user nodes in which each node of respective clusters is within a maximum distance to at least one other node of the respective clusters.

30. The method of claim 29, further comprising imposing an inter-cluster connectivity constraint that requires at least one activated link between a node within one of the one or more clusters and a node outside the one cluster.

31. A system for wireless communication, comprising:
means for maximizing channel reuse in assigning available wireless channels to ad-hoc wireless communication among pairs of secondary user nodes, subject at least to an interference constraint; and
means for assigning a transmit power to one pair of nodes that is predetermined from a location characteristic of the respective pair of nodes.
